(19) United States
(12) Patent Application Publication
(10) Pub. No.: US 2005/0221795 A1
(43) Pub. Date: Oct. 6, 2005

(54) Base station rental service system and base station thereof

(75) Inventors: Masashi Hirabe, Tokyo (JP); Masaya Uchida, Tokyo (JP); Hiroki Tanaka, Tokyo (JP); Daisuke Kondo, Tokyo (JP); Emiko Sakuma, Tokyo (JP)

Correspondence Address: MCGINN & GIBB, PLLC, 8321 OLD COURTHOUSE ROAD, SUITE 200, VIENNA, VA, 22182-3817, US

(73) Assignee: NEC Corporation, Tokyo (JP)

(21) Appl. No.: 11/086,913

(22) Filed: Mar. 23, 2005

(30) Foreign Application Priority Data
Mar. 31, 2004 (JP) 101847/2004

(51) Int. Cl. H04M 11/00

(52) U.S. Cl. 455/409; 455/553.1

(57) ABSTRACT

A cellular phone base station rental service allows a communication service provider, without using the costs of installing base stations on its own, to expand communication service areas to any places desired by users. A system for providing this service includes a cellular phone base station that borrows partial or all communication resources of communication lines in a prescribed area from a cellular phone service provider that lends communication resources of lines, to perform communications through a public IP network, the cellular phone base station being disposed within the area, a terminal registration authenticating device for base station authenticates whether the cellular phone terminals are registered with the cellular phone base station, and only when they are authenticated to be registered, transmits information specific to the area of the base station to the cellular phone terminal, a terminal registration authenticating device for the cellular phone service provider determines whether the cellular phone terminals having not been authenticated to be registered are registered with the cellular phone service provider; and transmits the result. Communication services are performed using communication resources lent to only the cellular phone terminals having been authenticated to be registered, cellular phone terminals having not been authenticated to be registered are enabled to perform communications using surplus communication resources of the cellular phone base station.

### BACKGROUND OF THE INVENTION

1. Field of the Invention

The present invention relates to a cellular phone base station rental service system in which a cellular phone service provider provides a user a base station connectable to a mobile communication network through a public IP (Internet Protocol) network, the user purchases part or all of the communication resources of the lent base station, and terminals registered with the lent base station perform communications using the communication resources, and relates to the base station thereof. Hereinafter, the exemplary case of a cellular phone will be described, but of course the invention is equally applicable to other type of portable terminals.

2. Description of the Related Art

Conventional cellular phone services have been performed in such a way that a cellular phone service provider installs cellular phone base stations to perform cellular phone services, and individual cellular phone terminal users pay communication charges corresponding to communication usage to the communication service provider.

In recent years, cellular phones have become widespread to such an extent that almost every person has one cellular phone. Their use has increased not only during traveling but also at places, such as home and office, where a person typically spends a lot of time. In the future, the cellular phones are even expected to be used for information transmission from home appliances.

Cellular phone charges, which are higher than fixed phone (e.g., so called “hard-wired”) charges, must be reduced at least within limited areas so that communications can be performed at charges comparable to fixed phone charges.

Information transmission from home appliances will probably be performed independently of the intention of cellular phone terminal users. Therefore, instead of an existing pay-by-use charging method, communication resources must be reserved in advance so that they can be used with users' own arrangements.

An access method related to the above-mentioned conventional system is proposed in Japanese Unexamined Patent Application No. 2002-344511.

However, in the conventional method, since cellular phone service providers have installed cellular phone base stations to expand service areas, they have borne the costs of installation, operation, and management, and have covered the costs by communication charges from terminals. Therefore, it has been difficult to install cellular phone base stations in areas where the number of terminals used is not expected to increase.

### SUMMARY OF THE INVENTION

In view of the foregoing and other exemplary problems, drawbacks, and disadvantages, an exemplary feature of the present invention is to provide a cellular phone base station rental service system that solves the above-mentioned problem, and its cellular phone base stations.

To attain such exemplary purposes and others, the present invention is characterized in that a cellular phone service provider lends a user a cellular phone base station connectable to a mobile communication network through a public IP network, the user purchases part or all of communication resources of the lent cellular phone base station, and cellular phone terminals registered with the lent cellular phone base station perform communications using the communication resources. The present invention is also characterized in that not-purchased communication resources of the lent cellular phone base station are released to unregistered terminals, and charges proportional to the released communication resources are returned to the users who borrow the cellular phone base stations. The users who borrow the cellular phone base station can transmit user-specific information to the terminals in an area of the cellular phone base station.

To realize the system, the present invention includes: a cellular phone base station that borrows partial or all communication resources of communication lines in a prescribed area from a cellular phone service provider that lends communication resources of lines, to perform communications with cellular phone terminals and communication devices on a mobile communication network through a public IP network, the cellular phone base station being disposed within the area; a terminal registration authenticating device for base station that authenticates whether the cellular phone terminals are registered with the cellular phone base station, and only when they are authenticated to be registered, transmits information specific to the area of the base station to the cellular phone terminals; and a terminal registration authenticating device for cellular phone service provider that determines whether the cellular phone terminals having not been authenticated to be registered by the terminal registration authenticating device for base station are registered with the cellular phone service provider on the communication resource lending side, and transmits the result to the terminal registration authenticating device for base station. With this configuration, communication services are performed using communication resources lent to only the cellular phone terminals having been authenticated to be registered, and the cellular phone terminals having not been authenticated to be registered are enabled to perform communications using surplus communication resources of the cellular phone base station.

An exemplary cellular phone base station of the present invention includes: an IP public network connection function part; a wireless communication function part that receives signals from the cellular phone terminals and transmits information from the communication network to the cellular phone terminals; an authentication communication function part that performs communications with the terminal registration authenticating device for base station; and a core communication function part that performs communications with a core communication network. The authentication communication function part and the core communication function part are connected to an IP public network through the IP public network connection function part, and perform communications with the terminal registration authenticating device for base station connected to the IP public network, and the core communication network.

An exemplary terminal registration authenticating device for base station of the present invention includes: an IP public network connection function part; a base station communication function part that performs communications with the cellular phone base station; a service provider authenticating device communication function part that performs communications with the terminal registration authenticating device for cellular phone service provider; a base station information server that holds information specific to abase station area in terminals within an area of the cellular phone base station, and transmits the information; and a terminal registration authentication function part for base station that determines whether the cellular phone terminal accessing the cellular phone base station is registered with the base station, and requests authentication to the terminal registration authenticating device for cellular phone service provider. The base station communication function part and the service provider authenticating device communication function part are connected to the IP public network by the IP public network connection function part, and perform communications with the cellular phone base station within the IP public network, or the registration authenticating device for cellular phone service provider within the core communication network.

Another exemplary terminal registration authenticating device for cellular phone service provider includes: a core communication network connection function part; a registration authenticating communication function part for base station that is connected to the core communication network through the core communication network connection function part, and performs communications with the terminal registration authenticating device for base station through the core communication network and the IP public network; and a terminal registration authentication function part for cellular phone service provider that determines whether a cellular phone terminal having not been authenticated to be registered by the terminal registration authenticating device for base station is registered with the cellular phone service provider on the communication resource lending side.

An exemplary base station of the present invention includes a charging device that, when communications have been performed using surplus communication resources except the lent communication resources within the cellular phone base station, charges communication charges having been used by cellular phone terminals that are not registered with the base station and registered with the cellular phone service provider, as well as communication resource usage charges on users borrowing the cellular phone base station.

As has been described above, according to the present invention, by lending the cellular phone base stations to the users, the communication service provider can expand communication service areas to any places desired by the users without using the costs of installing the base stations on its own.

The cellular phone service provider lends cellular phone base stations, and can expand service areas without installing base stations on its own by not-purchased communication resources of the cellular phone base stations.

By borrowing and installing a cellular phone base station, the users have the advantages of obtaining stable communication service areas at any desired places while performing communications at fixed charges.

Moreover, the users can expand their own communication services by purchasing communication resources and using the function of registering terminals in the base station terminal registration authenticating device and an information notice function employing a base station information server. For example, if the system is introduced into a store and used so that advertisements are performed using the information notice function employing the base station information server or in-store free communication services are performed by registering terminals of members of the store, the system will contribute to attracting customers. Moreover, by holding member identities and notice information of the individual members in the base station information server, a service can be provided for transmitting member-specific guides and information to the members.

By releasing not-purchased communication resources of the cellular phone base stations to unregistered terminals, the users can obtain the usage charges from the cellular phone service provider. Therefore, by adjusting the balance between the size of communication resources of the cellular phone base stations and the size of communication resources to be purchased, the costs of user-specific communication services can be optimized.

### BRIEF DESCRIPTION OF THE DRAWINGS

The above and other exemplary aspects, features and advantages of the present invention will become more apparent from the following detailed description when taken in conjunction with the accompanying drawings wherein:

FIG. 1 is a drawing showing the configuration of an exemplary cellular phone base station rental service system of the present invention;

FIG. 2 is a drawing showing the configuration of a cellular phone base station of the present invention;

FIG. 3 is a drawing showing the configuration of a terminal registration authenticating device for base station of the present invention;

FIG. 4 is a drawing showing the configuration of a terminal registration authenticating device for communication service provider of the present invention;

FIG. 5 is a drawing showing the exchange of signals between devices in a communication network of the present invention; and

FIG. 6 is a drawing showing a flow from rental of a cellular phone base station of the present invention to execution of communication service.

### DETAILED DESCRIPTION OF EXEMPLARY EMBODIMENTS

Exemplary embodiments of the present invention will be described below in detail with reference to the drawings.

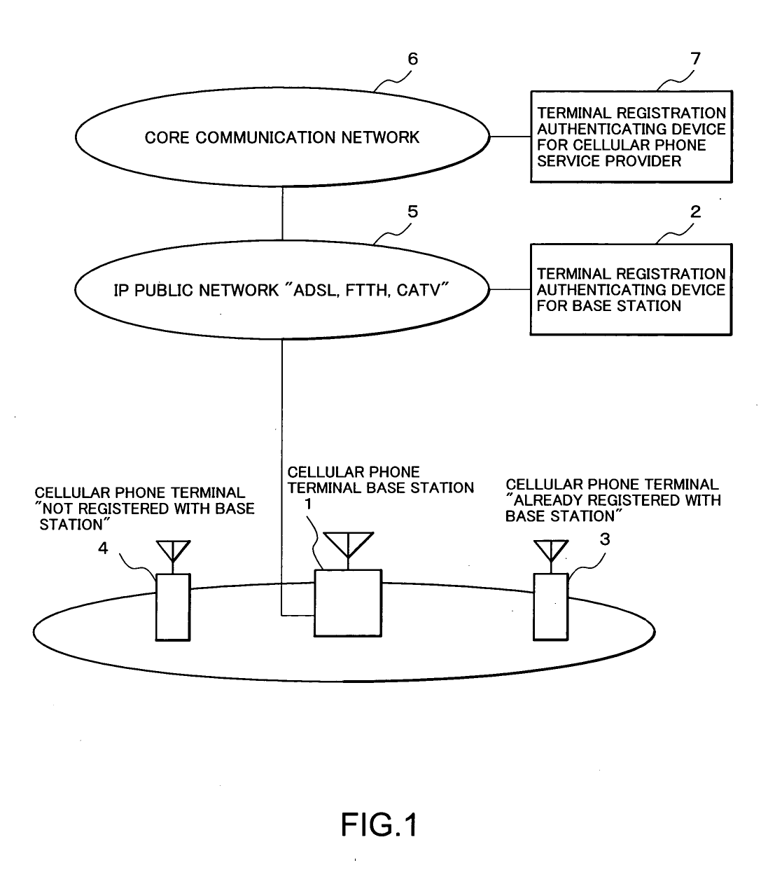

An exemplary embodiment of the present invention will be described with reference to FIG. 1. The present embodiment includes a cellular phone base station 1, a terminal registration authenticating device 2 for base station (hereinafter simply referred to as “registration authenticating device 2”), a terminal registration authenticating device for cellular phone service provider 7 (hereinafter simply referred to as “registration authenticating device 7”), and cellular phone terminals 3 and 4. The cellular phone base station 1 is connected to a core communication network 6 through an IP public network 5 such as ADSL (Asymmetric Digital Subscriber Line), FTTH (Fiber To The Home), and CATV (Community Antenna TeleVision). The registration authenticating device 2 is connected to the IP public network 5. Assume that the cellular phone terminals 3 and 4 are in a place accessible to the cellular phone base station 1, the cellular phone terminal 3 is a terminal registered with the registration authenticating device 2, and the cellular phone terminal 4 is a terminal not registered with the registration authenticating device 2.

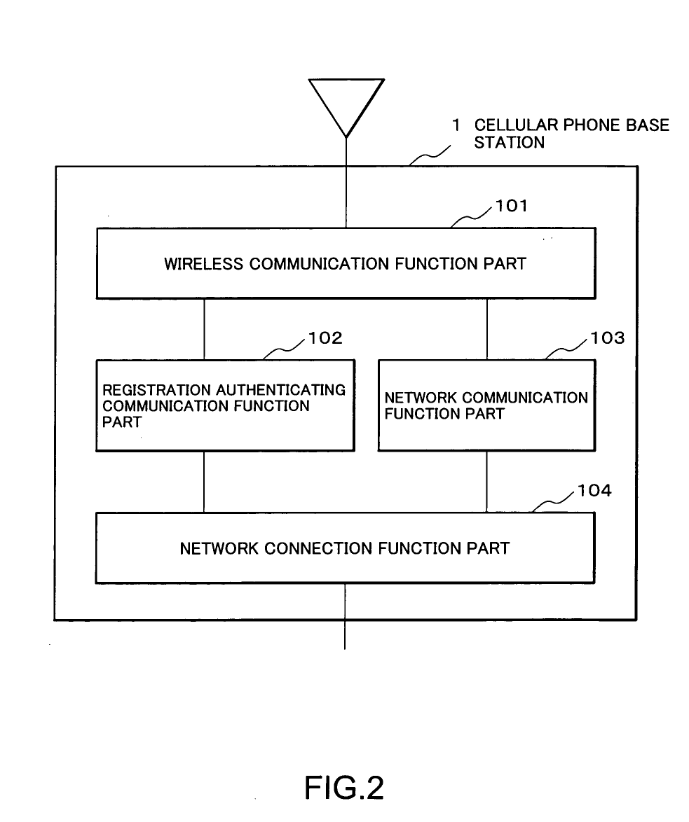

FIG. 2 shows the configuration of the cellular phone base station 1. The cellular phone base station 1 includes a wireless communication function part 101, a registration authenticating communication function part 102, a network communication function part 103, and a network connection function part 104. The registration authenticating communication function part 102 performs communications with the registration authenticating device 2. The network communication function part 103 performs communications with the core communication network. The wireless communication function part 101 receives a,signal from the cellular phone terminals, or transmits information from the communication network to the cellular phone terminals. Since the registration authenticating communication function part 102 and the network communication function part 103 are connected to the IP public network 5 by the network connection function part 104, they can communicate with the terminal registration authenticating device 2 and the core communication network 6.

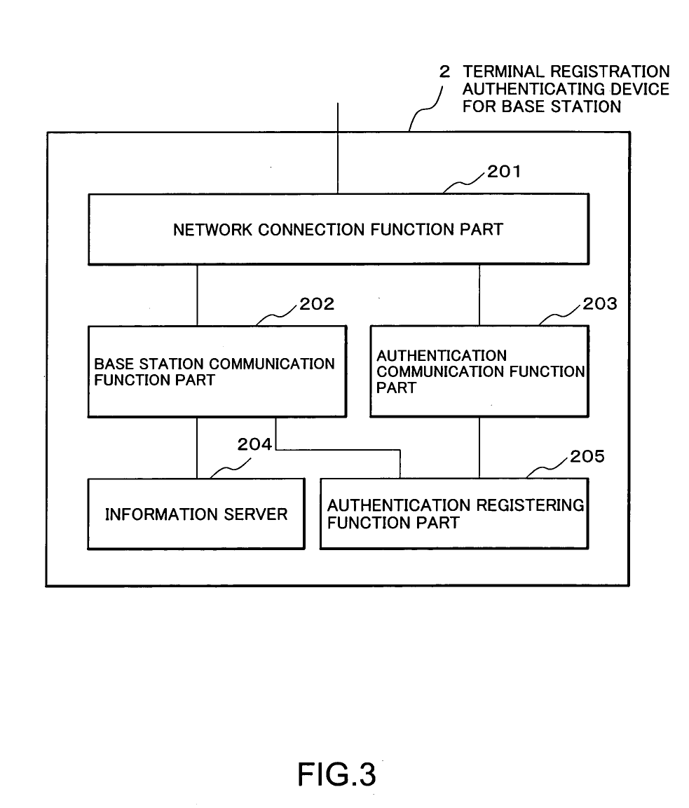

FIG. 3 shows the configuration of the registration authenticating device 2. The registration authenticating device 2 includes a network connection function part 201, a base station communication function part 202, an authentication communication function part 203, an information server 204, and an authentication registering function part 205. The base station communication function part 202 performs communications with the cellular phone base station 1. The authentication communication function part 203 performs communications with the registration authenticating device 7. The base station communication function part 202 and the authentication communication function part 203 are connected to the IP public network 5 by the network connection function part 201, and communicate with the cellular phone base station 1 in the IP public network 5 and the registration authenticating device 7 in the core communication network 6. The authentication registering function part 205 determines whether a cellular phone terminal that has accessed the cellular phone base station 1 has been registered with the cellular phone base station 1, and requests authentication to the registration authenticating device 7. The information server 204 holds information specific to a base station area in terminals within the area of the cellular phone base station 1 and has a function to transmit the information.

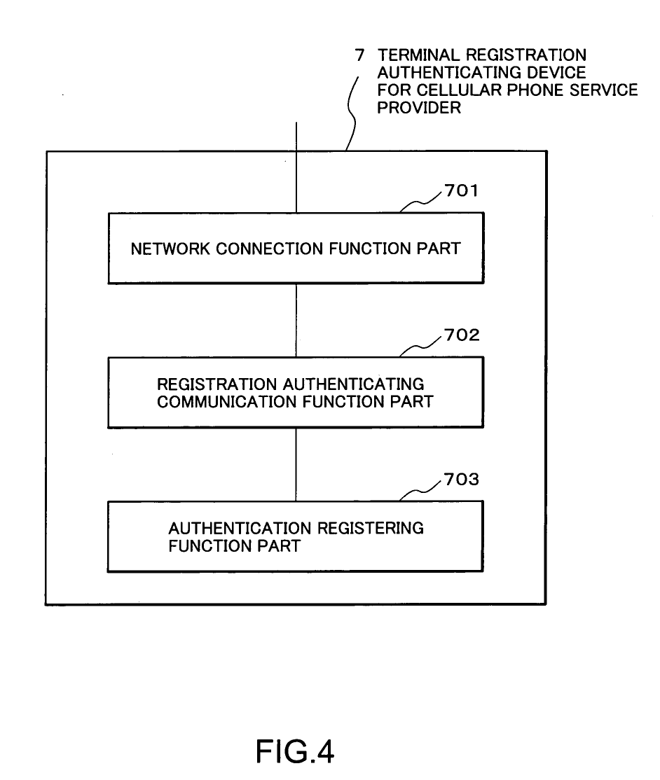

FIG. 4 shows the configuration of the registration authenticating device 7. The registration authenticating device 7 includes a network connection function part 701, a registration authenticating communication function part 702, and an authentication registering function part 703 for cellular phone service provider. The registration authenticating communication function part 702 performs communications with the registration authenticating device 2. The registration authenticating communication function 702 performing communications with the registration authenticating device 2 is connected to the core communication network 6 by the network connection function 701, and performs communications with the registration authenticating device 2 through the core communication network 6 and the IP public network 5.

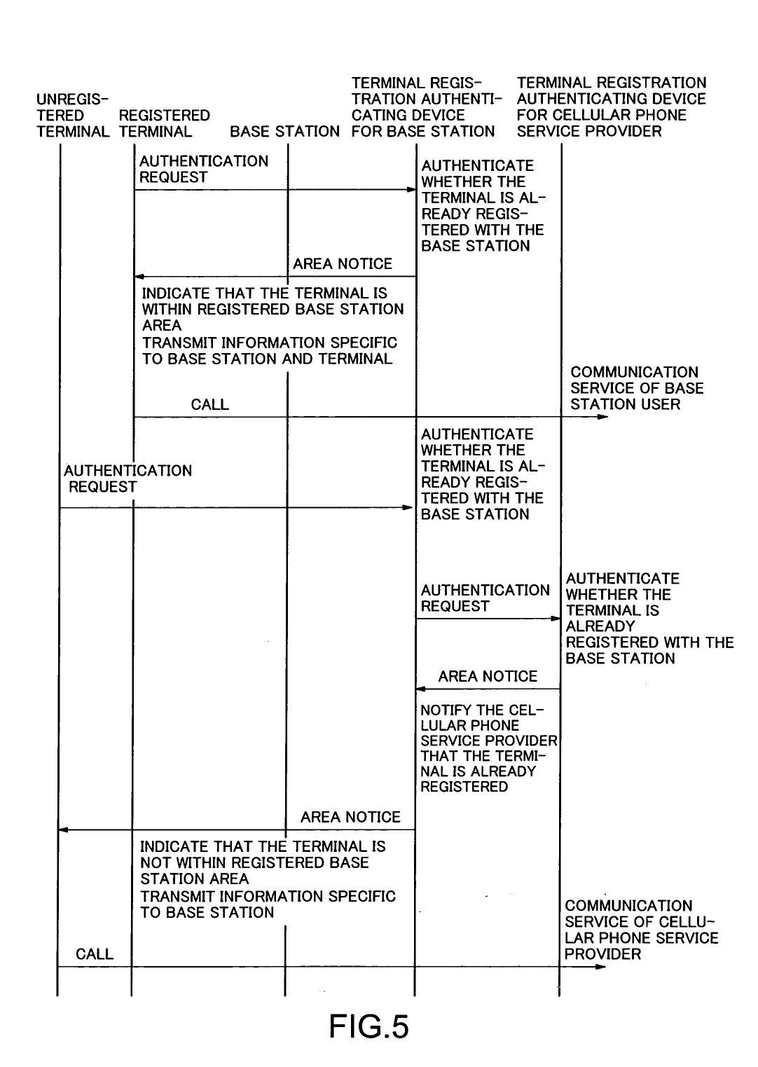

The following describes the operation of the system according to the present embodiment. FIG. 5 shows the exchange of signals between devices in the communication network.

When a registered cellular phone terminal 3 has traveled to an area of the cellular phone base station 1, it requests authentication to the registration authenticating device 2. Upon determining that the accessing cellular phone terminal 3 is a registered cellular phone terminal, the registration authenticating device 2 notifies the cellular phone terminal 3 of being in the base station area in which it has been registered, and transmits to the cellular phone terminal 3 the information specific to the area of the cellular phone base station 1 that is registered with the information server 204. The user of the cellular phone terminal 3 recognizes receiving communication services of a borrower of the cellular phone base station 1 in the area of the cellular phone base station 1 in which it has been registered, and starts communications.

When an unregistered cellular phone terminal 4 has traveled to an area of the cellular phone base station 1, it requests authentication to the registration authenticating device 2. Upon determining that the accessing cellular phone terminal 4 is an unregistered cellular phone terminal, the registration authenticating device 2 requests authentication of the cellular phone terminal 4 to the registration authenticating device 7. The registration authenticating device 7 determines whether the cellular phone terminal that has made access through the registration authenticating device 2 is registered with the cellular phone service provider, and transmits the result of determination to the registration authenticating device 2. The registration authenticating device 2 notifies the cellular phone terminal 4 that it is not registered with the cellular phone base station 2, and transmits to it information specific to the area of the cellular phone base station 1.

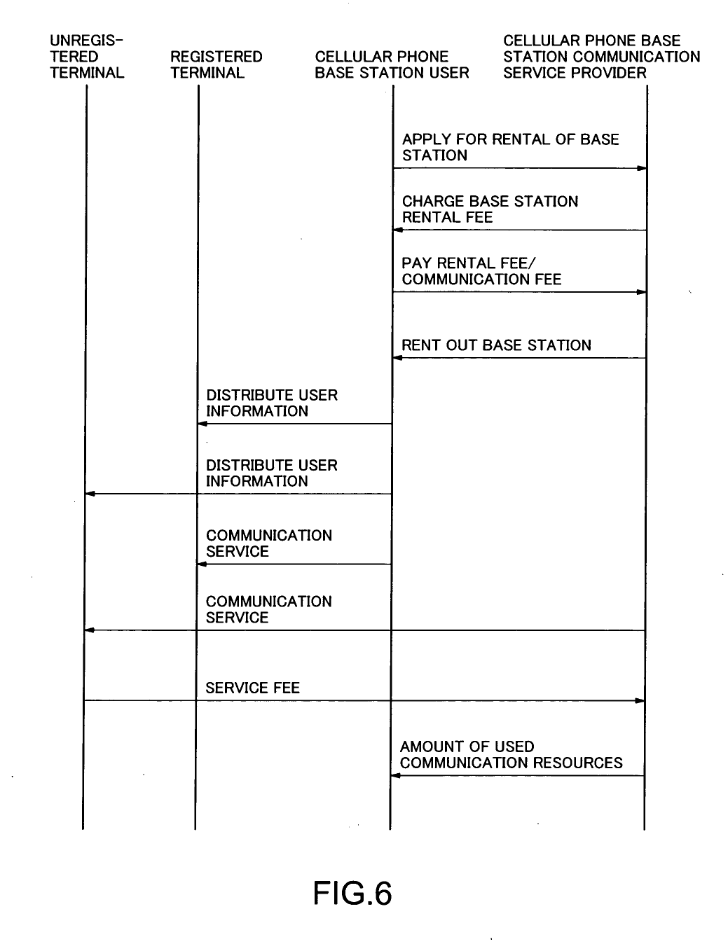

FIG. 6 shows a flow of processing after the user of the cellular phone base station rents the cellular phone base station 1 until communication services are started. The user who wants to rent the cellular phone base station 1 applies for its rental to the cellular phone service provider. At this time, the user offers communication resources (number of users, data capacity, and the like) of a desired cellular phone base station, communication resources to be used, the number of terminals to be registered with the authentication registering function part 205, and the capacity of desired information server 204.

Based on the information offered from the user, the cellular phone service provider charges the user for a base station rental charge, a communication resource usage charge, a usage charge of the authentication registering function part 205, and a usage charge of the information server 204. The user pays these charges to borrow the cellular phone base station 1 from the cellular phone service provider.

By connecting the cellular phone base station 1 to the IP public network 5, and registering the cellular phone terminal in the registration authenticating device 2, the user can share the communication resources purchased by paying the usage charge among registered terminals. The information registered by the user in the information server 204 to which the user paid the usage charge is transmitted to terminals in the area of the cellular phone base station 1. By registering a registered cellular phone terminal ID and the information in combination in the information server 204, user-specific information can be transmitted from the user to the registered terminals.

The communication resources of the cellular phone base station 1 the user borrows, and the communication resources for which the user pays to the cellular phone service provider do not necessarily need to match in quantity; the communication resources of the cellular phone base station 1 may be vast. In this case, the surplus communication resources of the cellular phone base station 1 may be used by general cellular phone terminals that are not registered with the registration authenticating device 2 and registered with the cellular phone service provider based on their usage. The users of the unregistered cellular phone terminals pay a communication charge to the cellular phone service provider. The cellular phone service provider pays the communication resource usage charge to the user who borrows the cellular phone base station 1.

A charging- device used in the above-mentioned usage charge payment, though not shown, is provided within the base station. When communications are performed using communication resources except lent communication resources within the base station, the charging device charges communication charges for communications of the cellular phone terminal 4 that is not registered with the base station and registered with the cellular phone service provider. Also, the charging device charges communication resource usage charges to users renting communication lines within a prescribed area of the cellular phone base station 1.

When communications are performed using communication resources except lent communication resources within the base station, account information of communication charge is transmitted from a terminal (not shown) of the cellular phone service provider to the cellular phone terminal 4 that is not registered with the base station and registered with the cellular phone service provider. Account information of communication resources usage charges is transmitted to the terminal of the cellular phone service provider from the users who rent the communication lines in the prescribed area of the cellular phone base station 1.

As has been described above, according to the present invention, the communication service provider can expand communication service areas to any places desired by users without incurring the costs of installing base stations on its own.

The cellular phone service provider can expand service areas without installing base stations on its own by using not-purchased communication resources of the cellular phone base stations.

By borrowing and installing a cellular phone base station, the users can obtain stable communication service areas at any desired places while performing communications at a fixed charge.

The users can expand their own communication services by purchasing communication resources, registering terminals in abase station terminal registration authenticating device, and using an information notice function employing a base station information server.

Moreover, the users can optimize the costs of user-specific communication services by adjusting the balance between the size of communication resources of a cellular phone base station and the size of communication resources to be purchased.

While this invention has been described in connection with certain exemplary embodiments, it is to be understood that the subject matter encompassed by way of this invention is not to be limited to those specific embodiments. On the contrary, it is intended for the subject matter of the invention to include all alternatives, modifications and equivalents as can be included within the spirit and scope of the following claims.

Further, it is the inventor's intent to retain all equivalents of the claimed invention even if the claims are amended during prosecution.

1. A cellular phone base station rental service system, including:
a cellular phone base station that borrows at least partial communication resources of communication lines in a prescribed area from a cellular phone service provider that lends communication resources of lines, to perform communications with cellular phone terminals and communication devices on a mobile communication network through a public IP network, the cellular phone base station being disposed within the area;
a terminal registration authenticating device for the base station that authenticates whether the cellular phone terminals are registered with the cellular phone base station, and when they are authenticated to be registered, transmits information specific to the area of the base station to the cellular phone terminals; and
a terminal registration authenticating device for the cellular phone service provider that determines whether cellular phone terminals having not been authenticated to be registered by the terminal registration authenticating device for the base station are registered with the cellular phone service provider on a communication resource lending side, and transmits a result to the terminal registration authenticating device for the base station,
wherein communication services are performed using communication resources lent to the cellular phone terminals having been authenticated to be registered, and the cellular phone terminals having not been authenticated to be registered are enabled to perform communications using surplus communication resources of the cellular phone base station.

2. The cellular phone base station rental service system as claimed in claim 1, wherein the cellular phone base station includes:
an IP public network connection function part;
a wireless communication function part that receives signals from the cellular phone terminals and transmits information from the communication network to the cellular phone terminals;
an authentication communication function part that performs communications with the terminal registration authenticating device for the base station; and
a core communication function part that performs communications with a core communication network,
wherein the authentication communication function part and the core communication function part are connected to an IP public network through the IP public network connection function part, and perform communications with the terminal registration authenticating device for the base station connected to the IP public network, and the core communication network.

3. The cellular phone base station rental service system as claimed in claim 1, wherein the terminal registration authenticating device for base station includes:
an IP public network connection function part;
a base station communication function part that performs communications with the cellular phone base station;
a service provider authenticating device communication function part that performs communications with the terminal registration authenticating device for the cellular phone service provider;
a base station information server that holds information specific to a base station area in terminals within an area of the cellular phone base station, and transmits the information; and
a terminal registration authentication function part for the base station that determines whether the cellular phone terminal accessing, the cellular phone base station is registered with the base station, and requests authentication to the terminal registration authenticating device for cellular phone service provider,
wherein the base station communication function part and the service provider authenticating device communication function part are connected to the IP public network by the IP public network connection function part, and perform communications with the cellular phone base station within the IP public network, or the registration authenticating device for cellular phone service provider within the core communication network.

4. The cellular phone base station rental service system as claimed in claim 2, wherein the terminal registration authenticating device for base station includes:
an IP public network connection function part;
a base station communication function part that performs communications with the cellular phone base station;
a service provider authenticating device communication function part that performs communications with the terminal registration authenticating device for the cellular phone service provider;
a base station information server that holds information specific to a base station area in terminals within an area of the cellular phone base station, and transmits the information; and
a terminal registration authentication function part for the base station that determines whether the cellular phone terminal accessing the cellular phone base station is registered with the base station, and requests authentication to the terminal registration authenticating device for the cellular phone service provider,
wherein the base station communication function part and the service provider authenticating device communication function part are connected to the IP public network by the IP public network connection function part, and perform communications with the cellular phone base station within the IP public network, or the registration authenticating device for the cellular phone service provider within the core communication network.

5. The cellular phone base station rental service system as claimed in claim 1, wherein the terminal registration authenticating device for cellular phone service provider includes:
a core communication network connection function part;
a registration authenticating communication function part for the base station that is connected to the core communication network through the core communication network connection function part, and performs communications with the terminal registration authenticating device for the base station through the core communication network and the IP public network; and
a terminal registration authentication function part for the cellular phone service provider that determines whether a cellular phone terminal having not been authenticated to be registered by the terminal registration authenticating device for the base station is registered with the cellular phone service provider on a communication resource lending side.

6. The cellular phone base station rental service system as claimed in claim 2, wherein the terminal registration authenticating device for the cellular phone service provider includes:
a core communication network connection function part;
a registration authenticating communication function part for the base station that is connected to the core communication network through the core communication network connection function part, and performs communications with the terminal registration authenticating device for the base station through the core communication network and the IPpublic network; and
a terminal registration authentication function part for the cellular phone service provider that determines whether a cellular phone terminal having not been authenticated to be registered by the terminal registration authenticating device for the base station is registered with the cellular phone service provider on a communication resource lending side.

7. The cellular phone base station rental service system as claimed in claim 3, wherein the terminal registration authenticating device for cellular phone service provider includes:
a core communication network connection function part;
a registration authenticating communication function part for the base station that is connected to the core communication network through the core communication network connection function part, and performs communications with the terminal registration authenticating device for the base station through the core communication network and the IPpublic network; and
a terminal registration authentication function part for the cellular phone service provider that determines whether a cellular phone terminal having not been authenticated to be registered by the terminal registration authenticating device for the base station is registered with the cellular phone service provider on a communication resource lending side.

8. The cellular phone base station rental service system as claimed in claim 4, wherein the terminal registration authenticating device for cellular phone service provider includes:
a core communication network connection function part;
a registration authenticating communication function part for the base station that is connected to the core communication network through the core communication network connection function part, and performs communications with the terminal registration authenticating device for the base station through the core communication network and the IP public network; and
a terminal registration authentication function part for the cellular phone service provider that determines whether a cellular phone terminal having not been authenticated to be registered by the terminal registration authenticating device for the base station is registered with the cellular phone service provider on a communication resource lending side.

9. The cellular phone base station rental service system as claimed in claim 1, wherein the base station includes:
a charging device that, when communications have been performed using surplus communication resources except lent communication resources within the cellular phone base station, charges communication charges having been used by cellular phone terminals that are not registered with the base station and registered with the cellular phone service provider, as well as communication resource usage charges on users borrowing the cellular phone base station.

10. The cellular phone base station rental service system as claimed in claim 2, wherein the base station includes:
a charging device that, when communications have been performed using surplus communication resources except lent communication resources within the cellular phone base station, charges communication charges having been used by cellular phone terminals that are not registered with the base station and registered with the cellular phone service provider, as well as communication resource usage charges on users borrowing the cellular phone base station.

11. The cellular phone base station rental service system as claimed in claim 3,
wherein the base station includes:
a charging device that, when communications have been performed using surplus communication resources except lent communication resources within the cellular phone base station, charges communication charges having been used by cellular phone terminals that are not registered with the base station and registered with the cellular phone service provider, as well as communication resource usage charges on users borrowing the cellular phone base station.

12. The cellular phone base station rental service system as claimed in claim 4, wherein the base station includes:
a charging device that, when communications are performed using surplus communication resources except lent communication resources within the cellular phone base station, charges communication charges having been used by cellular phone terminals that are not registered with the base station and registered with the cellular phone service provider, as well as communication resource usage charges on users borrowing the cellular phone base station.

13. The cellular phone base station rental service system as claimed in claim 5, wherein the base station includes:
a charging device that, when communications are performed using surplus communication resources except lent communication resources within the cellular phone base station, charges communication charges having been used by cellular phone terminals that are not registered with the base station and registered with the cellular phone service provider, as well as communication resource usage charges on users borrowing the cellular phone base station.

14. The cellular phone base station rental service system as claimed in claim 6, wherein the base station includes:
a charging device that, when communications are performed using surplus communication resources except lent communication resources within the cellular phone base station, charges communication charges having been used by cellular phone terminals that are not registered with the base station and registered with the cellular phone service provider, as well as communication resource usage charges on users borrowing the cellular phone base station.

15. The cellular phone base station rental service system as claimed in claim 7, wherein the base station includes:
a charging device that, when communications are performed using surplus communication resources except lent communication resources within the cellular phone base station, charges communication charges having been used by cellular phone terminals that are not registered with the base station and registered with the cellular phone service provider, as well as communication resource usage charges on users borrowing the cellular phone base station.

16. The cellular phone base station rental service system as claimed in claim 8, wherein the base station includes:
a charging device that, when communications are performed using surplus communication resources except lent communication resources within the cellular phone base station, charges communication charges having been used by cellular phone terminals that are not registered with the base station and registered with the cellular phone service provider, as well as communication resource usage charges on users borrowing the cellular phone base station.

17. A cellular phone base station device, including:
an IP public network connection function part for connecting to an IP public network;
a wireless communication function part that receives a signal from a cellular phone terminal, and transmits information from the communication network to a cellular phone terminal;
an authentication communication function part that transmits a request of the cellular phone terminal for registration authentication in a base station terminal, and receives information indicating whether the cellular phone terminal is authenticated to be registered with the base station terminal, from a registration authenticating device through the IP public network; and
a core communication function part that performs communications with a core communication network, wherein the authentication communication function part and the core communication function part are connected to the IP public network through the IP public network connection function part, and perform communications with the terminal registration authenticating device for the base station connected to the IP concerned public network, and the core communication network.

18. A cellular phone base station rental service method that performs communications between cellular phone terminals and communication devices on a mobile communication network through a public IP network by borrowing partial or all communication resources of communication lines within an area of a cellular phone base station from a cellular phone service provider that lends communication resources of the cellular phone base station, the method including:
authenticating whether the cellular phone terminals are registered with the cellular phone base station;
when they are authenticated to be registered, transmitting information specific to the area of the base station to the cellular phone terminals;
determining whether the cellular phone terminals having not been authenticated to be registered are registered with the cellular phone service provider on a communication resource lending side;
after the information specific to the area of the base station is transmitted, performing communication services using communication resources lent to only the cellular phone terminals authenticated to be registered; and
when the cellular phone terminals having not been authenticated to be registered are registered with the cellular phone service provider, for cellular phone terminals that are not registered with the base station and registered with the cellular phone service provider, performing communications using surplus communication resources except the lent communication resources within the cellular phonebase station.

19. The cellular phone base station rental service method as claimed in claim 18, further comprising:
when communications are performed using surplus communication resources except the lent communication resources within the cellular phone base station, transmitting, from the cellular phone service provider terminal, information on charging communication charges to the cellular phone terminals that are not registered with the base station and registered with the cellular phone service provider.

20. The cellular phone base station rental service method as claimed in claim 19, further comprising:
transmitting information on charging communication resource usage charges from users borrowing the cellular phone base station to the cellular phone service provider terminal.

21. A signal-bearing medium tangibly embodying a program of machine-readable instructions executable by a digital processing apparatus to execute a method of performing communications between cellular phone terminals and communication devices on a mobile communication network through a public IP network by borrowing at least partial communication resources of communication lines within an area of a cellular phone base station from a cellular phone service provider that lends communication resources of the cellular phone base station, the method comprising:
authenticating whether the cellular phone terminals are registered with the cellular phone base station;
only when they are authenticated to be registered, transmitting information specific to an area of the base station to the cellular phone terminals;
determining whether the cellular phone terminals having not been authenticated to be registered are registered with the cellular phone service provider on a communication resource lending side;
after the information specific to the area of the base station is transmitted, performing communication services using communication resources lent to the cellular phone terminals authenticated to be registered; and
when the cellular phone terminals having not been authenticated to be registered are registered with the cellular phone service provider, for cellular phone terminals that are not registered with the base station and registered with the cellular phone service provider, performing communications using surplus communication resources except the lent communication resources within the cellular phone base station.

22. The medium of claim 21, wherein the medium comprises a compact disk, flexible disk, hard disk, magnet-optical disk, digital video disk, magnetic tape, or semiconductor memory.

23. A cellular phone base station rental service system, comprising:
a cellular phone base station whose communication resources of communication lines in a prescribed area have been partially or completely borrowed from a cellular phone service provider that lends communication resources of lines, to perform communications with cellular phone terminals and communication devices on a mobile communication network through a public IP network, the cellular phone base station being disposed within the area; and
a terminal registration authenticating device for said base station that authenticates whether the cellular phone terminals are registered with the cellular phone base station, and when they are authenticated to be registered, transmits information specific to an area of the base station to the cellular phone terminals, wherein:
a terminal registration authenticating device for cellular phone service provider determines whether the cellular phone terminals having not been authenticated to be registered by the terminal registration authenticating device for said base station are registered with the cellular phone service provider on the communication resource lending side, and transmits a result to the terminal registration authenticating device for said base station, and
communication services are performed using communication resources lent to only the cellular phone terminals having been authenticated to be registered, and the cellular phone terminals having not been authenticated to be registered are enabled to perform communications using surplus communication resources of the cellular phone base station.

24. A cellular phone base station rental service system, comprising:
a terminal registration authenticating device for a cellular phone service provider that determines whether cellular phone terminals having not been authenticated to be registered by a terminal registration authenticating device for a base station are registered with the cellular phone service provider on a communication resource lending side, and transmits a result to the terminal registration authenticating device for said base station, wherein:
a cellular phone base station whose communication resources of communication lines in a prescribed area having been partially or completely borrowed from a cellular phone service provider that lends communication resources of lines, performs communications with cellular phone terminals and communication devices on a mobile communication network through a public IP network, the cellular phone base station being disposed within the area;
a terminal registration authenticating device for base station authenticates whether the cellular phone terminals are registered with the cellular phone base station, and when they are authenticated to be registered, transmits information specific to the area of the base station to the cellular phone terminals; and
communication services are performed using communication resources lent to only the cellular phone terminals having been authenticated to be registered, and the cellular phone terminals having not been authenticated to be registered are enabled to perform communications using surplus communication resources of the cellular phone base station.

25. A method of introducing a cellular phone service into an area, said method comprising:
acquiring partial or all communication resources of communication lines of a cellular phone base station in a prescribed area from a cellular phone service provider that lends communication resources of lines, to perform communications with cellular phone terminals and communication devices on a mobile communication network through a public IP network, the cellular phone base station being disposed within the area,
said base station including a terminal registration authenticating device for said base station that authenticates whether the cellular phone terminals are registered with the cellular phone base station, and when they are authenticated to be registered, transmits information specific to an area of the base station to the cellular phone terminals, wherein:
a terminal registration authenticating device for cellular phone service provider determines whether the cellular phone terminals having not been authenticated to be registered by the terminal registration authenticating device for said base station are registered with the cellular phone service provider on the communication resource lending side, and transmits a result to the terminal registration authenticating device for said base station, and
communication services are performed using communication resources lent to only the cellular phone terminals having been authenticated to be registered, and the cellular phone terminals having not been authenticated to be registered are enabled to perform communications using surplus communication resources of the cellular phone base station.
